(19) United States
(12) Patent Application Publication
(10) Pub. No.: US 2007/0261244 A1
(43) Pub. Date: Nov. 15, 2007

(54) Leveling Method for Embedding Heat Pipe in Heat-Conducting Seat

(76) Inventors: Chih-Hung Cheng, Wugu Township (TW); Kuo-Len Lin, Wugu Township (TW); Ken Hsu, Wugu Township (TW)

Correspondence Address: HDSL, 4331 STEVENS BATTLE LANE, FAIRFAX, VA, 22033, US

(21) Appl. No.: 11/383,192

(22) Filed: May 12, 2006

(51) Int. Cl. B21D 53/02; B23P 6/00

(52) U.S. Cl. 29/890.03; 29/890.032

(57) ABSTRACT

A leveling method for embedding a heat pipe in a heat-conducting seat includes preparing at least one heat pipe and a heat-conducting seat connected to the heat pipe, providing grooves at the bottom surface of the heat-conducting seat for embedding the heat pipe therein; horizontally arranging the heat pipe into the groove of the heat-conducting seat, pressing inwardly the portion of the heat pipe projecting from the groove into the groove via a first upper mold, forming a concave surface on the contacting surface between the first upper mold and the heat pipe; and pressing the heat pipe via a second upper mold to make the contacting surface between the second upper mold and the heat pipe substantially a leveled surface. In this way, the stress concentration caused by the pressing operation of the heat pipe can be reduced, and thus a more leveled surface to be heated of the heat pipe can be obtained.

### BACKGROUND OF THE INVENTION

1. Field of the Invention

The present invention relates to a leveling method for embedding a heat pipe in a heat-conducting seat, and in particular to a leveling method by which the heat pipe is embedded in the bottom surface of the heat-conducting seat, so that the heat pipe can be formed with a leveled surface to be heated and thus directly contacts with a heat source when the bottom surface of the heat-conducting seat contacts with the heat source.

2. Description of Prior Art

As shown in FIG. 1, which is a schematic perspective view showing the conventional heat pipe after being pressed. The heat pipe 1a is formed at its pipe body with a section 10a to be heated. The section 10a to be heated is directly brought into a face-to-face contact with a heat source. The bottom of the section 10a to be heated is pressed to form a flat surface 100a to be heated. However, during the pressing operation, the mold is necessary to be a flat surface. When a plane contacts with a convex surface, the contact between these surfaces gradually changes from a point contact to a surface contact. Owing to the stress concentration of the original point contact, the surface 100a to be heated of the heat pipe 1a is thus recessed inwardly to form a recessed portion 101a. As a result, after the pressing operation, it is still necessary to grind the surface 100a to be heated of the heat pipe 1a to eliminate the recessed portion 101a.

In view of the above, the inventor proposes the present invention to overcome the above problems based on his expert experiences and deliberate researches.

### SUMMARY OF THE INVENTION

The present invention is to provide a leveling method for embedding a heat pipe in a heat-conducting seat capable of solving the above problems. Two stages of the pressing operation are used to reduce the stress concentration. As a result, after being pressed, the surface to be heated of the heat pipe becomes much flatter and more suitable for the face-to-face contact during the heat conduction.

The present invention provides a leveling method for embedding a heat pipe in a heat-conducting seat, comprising the steps of:

a) preparing at least one heat pipe and a heat-conducting seat for being thermally connected to the heat pipe, providing grooves at the bottom surface of the heat-conducting seat for embedding the heat pipe therein;

b) horizontally arranging the heat pipe into the groove of the heat-conducting seat, pressing inwardly the portion of the heat pipe projecting from the groove into the groove via a first upper mold, forming a concave surface on the contacting surface between the first upper mold and the heat pipe;

c) pressing the heat pipe via a second upper mold to make the contacting surface between the second upper mold and the heat pipe substantially a leveled surface.

In this way, the stress concentration caused by the pressing operation of the heat pipe can be reduced, and thus a more leveled surface to be heated of the heat pipe can be obtained.

### BRIEF DESCRIPTION OF THE DRAWINGS

FIG. 1 is a schematic perspective view showing a conventional heat pipe after being pressed;

FIG. 2 is a schematic view showing the action before the first upper mold of the present invention presses the heat pipe;

FIG. 3 is an enlarged view showing the detail of part A in FIG. 1;

FIG. 4 is a schematic view showing the action after the first upper mold of the present invention has pressed the heat pipe;

FIG. 5 is a partially enlarged view showing the state after the first upper mold of the present invention has pressed the heat pipe;

FIG. 6 is a schematic view showing the action before the second upper mold of the present invention presses the heat pipe;

FIG. 7 is a schematic view showing the action after the second upper mold of the present invention has pressed the heat pipe; and

FIG. 8 is a partially enlarged view showing the state after the second upper mold of the present invention has pressed the heat pipe.

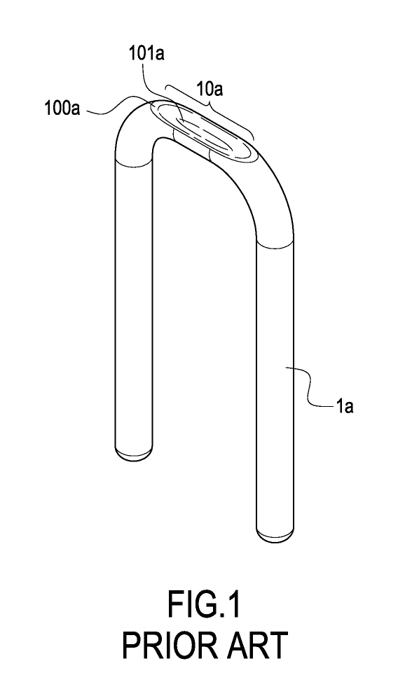

### DETAILED DESCRIPTION OF THE INVENTION

In order to make the Examiner better understand the characteristics and the technical contents of the present invention, a detailed description relating to the present invention will be made with reference to the accompanying drawings. However, it should be understood that the drawings are illustrative but not used to limit the scope of the present invention.

The present invention provides a leveling method for embedding a heat pipe in a heat-conducting seat, in which one or more heat pipes are embedded in the bottom surface of a heat-conducting seat. As a result, when the bottom surface of the heat-conducting seat contacts with a heat source, the heat pipe can form a flat surface to be heated and thus can be directly brought into a face-to-face contact with the heat source. The method in accordance with the present invention comprises the following steps:

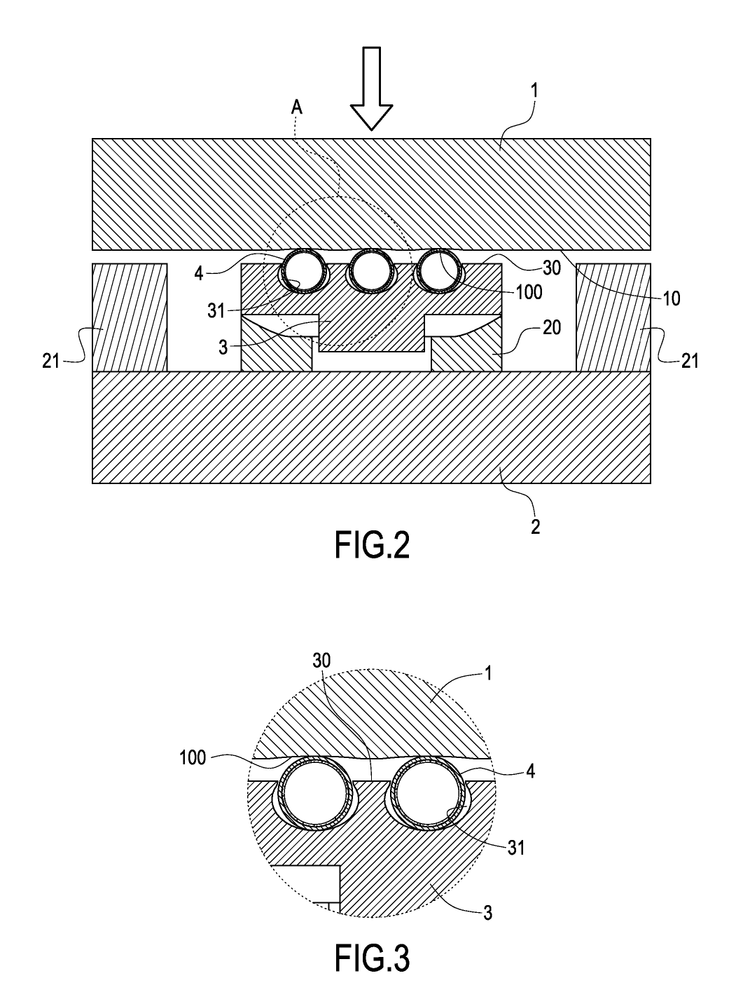

As showing in FIG. 2, at least one heat pipe 4 and a heat-conducting seat 3 used to be thermally connected with the heat pipe 4 are prepared. The bottom surface 30 of the heat-conducting seat 3 is provided with grooves 31 for embedding the heat pipes 4 therein, so that the heat pipes 4 can be horizontally arranged in the grooves 31 of the heat-conducting seat. The groove 31 is formed into a slightly oval shape. When the heat pipe 4 is arranged in the groove 31, part of the circumferential surface of the heat pipe 4 is located higher than the bottom surface 30 of the heat-conducting seat 30 to project from the groove 31. The projecting portion of the heat pipe 4 is to be pressed at the subsequent step to form a leveled surface.

According to the above, the heat-conducting seat 3 together with the heat pipes 4 arranged in the grooves 31 are arranged on a fixing seat 20 of a lower mold 2. The bottom surface 30 of the heat-conducting seat 3 faces upward. The lower mold 2 is provided with the fixing seat 20, and in addition, both sides of the fixing seats 20 are further provided with a height-restricting block 21, respectively. The height of both heat-restricting blocks 21 is the same with each other and is substantially flush with the bottom surface 30 of the heat-conducting seat 3. When the first and second upper mold 1, 1′ press downwardly at the subsequent step, both heat-restricting blocks 21 are used to be the lowest limit of the height of downward pressing so as to prevent the bottom surface 30 of the heat-conducting seat 3 from damaging due to the excessively downward pressing.

With reference to FIG. 2 and FIG. 3, the above-mentioned first upper mold 1 is located above the lower mold 2 for pressing downwardly the portion of the heat pipe 4 projecting from the groove 31, thereby to press the heat pipe 4 into the groove. The inner wall of the groove 31 can be applied to a heat-conducting medium, such as heat-conducting paste. After the heat pipe 4 is embedded in the groove 31, the heat-conducting medium is pressed and deformed to fill with the groove. With the heat-conducting paste, the contact effect between the heat pipe 4 and the inner wall of the groove 31 can be increased. Further, on the contacting surface 10 between the first upper mold 1 and the heat pipe 4, a concave surface 100 corresponding to the heat pipe 4 is formed (as shown in FIG. 3). Therefore, when the first upper mold 1 presses downwardly on the surface of the heat pipe 4, the concave surface 100 can produce a larger contacting surface with the heat pipe 4, thereby to reduce the stress concentration.

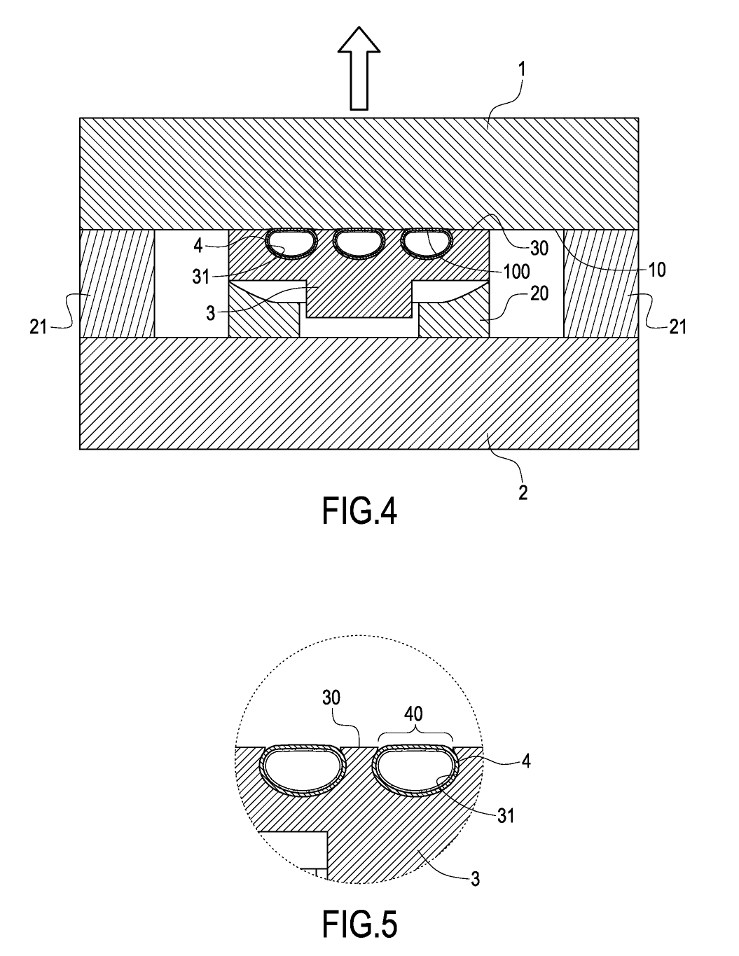

As shown in FIG. 4 and FIG. 5, after the first upper mold 1 has pressed the heat pipe 4 into the groove 31 of the heat-conducting seat 3, a slightly convex surface 40 to be heated can be formed on the heat pipe 4. Owing to the concave surface 100 of the first upper mold 1, the surface 40 to be heated will not be recessed inwardly.

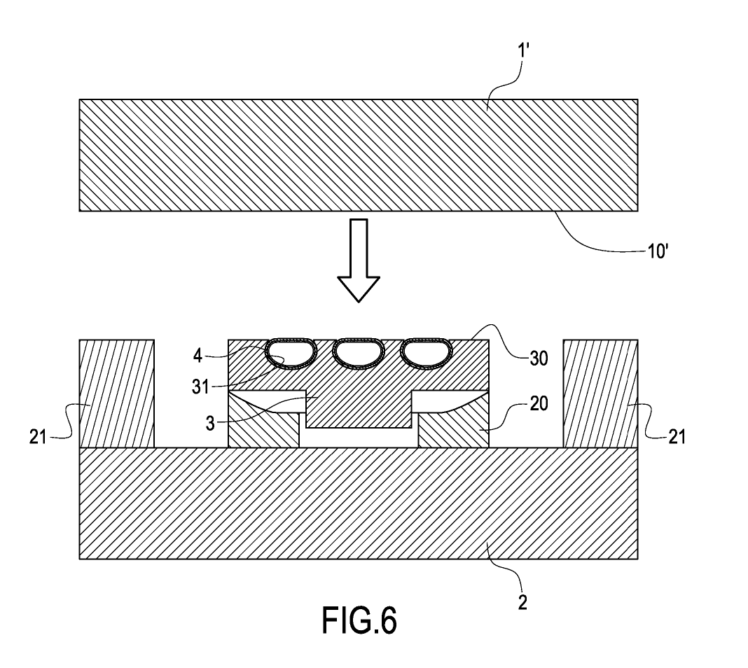

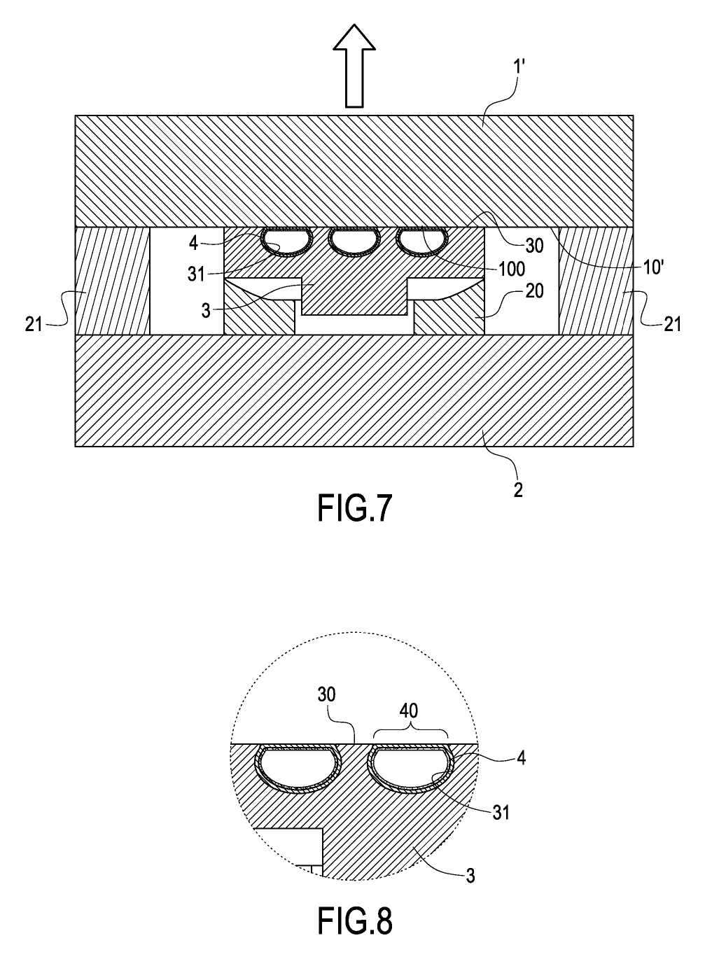

As shown in FIG. 6 and FIG. 7, after the first upper mold 1 exits the bottom surface 30 of the heat-conducting seat 3, the above-mentioned second upper mold 1′ is used to perform a second-time leveling action to the surface 40 to be heated of the heat pipe 4. The contacting surface 10′ between the second upper mold 1′ and the heat pipe 4 is a substantially flat surface, so that the slightly convex surface 40 to be heated can be pressed and leveled. Therefore, as shown in FIG. 8, the leveled surface 40 to be heated of the heat pipe 4 can be obtained.

Therefore, with the above construction, the leveling method for embedding a heat pipe in a heat-conducting seat in accordance with the present invention can be obtained.

Therefore, with the leveling method for embedding a heat pipe in a heat-conducting seat in accordance with the present invention, the stress concentration caused by pressing the heat pipe only one time can be reduced. Further, the surface to be heated of the heat pipe can be leveled to a greater extent. As a result, when directly adhering on the heat source, the flat surface can increase the effect of heat conduction so as to exhibit the desired heat-conducting performance of the heat pipe.

According to the above, the present invent indeed achieves the desired effects and overcomes the drawbacks of prior art by employing the above structures. Therefore, the present invention involves the novelty and inventive steps, and conforms to the requirements for an invention patent.

Although the present invention has been described with reference to the foregoing preferred embodiments, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A leveling method for embedding a heat pipe in a heat-conducting seat, comprising the steps of:
a) preparing at least one heat pipe and a heat-conducting seat thermally connected to the heat pipe, providing grooves at a bottom surface of the heat-conducting seat for embedding the heat pipe therein;
b) horizontally arranging the heat pipe into the groove of the heat-conducting seat, pressing inwardly a portion of the heat pipe projecting from the groove into the groove via a first upper mold, forming a concave surface on the contacting surface between the first upper mold and the heat pipe; and
c) pressing the heat pipe via a second upper mold to make a contacting surface between the second upper mold and the heat pipe substantially a leveled surface.

2. The method according to claim 1, wherein at the step b) an inner wall of the groove of the heat-conducting seat is applied to a heat-conducting medium.

3. The method according to claim 2, wherein the heat-conducting medium is a heat-conducting paste.

4. The method according to claim 1, wherein at the step b) the heat-conducting seat is arranged on a fixing seat of a lower mold with the bottom surface of the heat-conducting seat facing upwardly.

5. The method according to claim 4, wherein the lower mold is provided at both sides of the fixing seat with a height-restricting block, respectively, and a height of both height-restricting blocks is the same with each other and is substantially flush with the bottom surface of the heat-conducting seat.
